(19) United States
(12) Patent Application Publication
(10) Pub. No.: US 2026/0142251 A1
(43) Pub. Date: May 21, 2026

(54) PARALLEL CONNECTION BATTERY PACK ASSEMBLY EMPLOYING STRUCTURE FOR PREVENTING DAMAGE CAUSED BY INRUSH CURRENT TO BATTERY PACK

(71) Applicant: CTNS Co., Ltd., Changwon-si, Gyeongsangnam-do (KR)

(72) Inventor: Ki Bong YOO, Gimhae-si, Gyeongsangnam-do (KR)

(21) Appl. No.: 19/120,215

(22) PCT Filed: Nov. 3, 2023
(86) PCT No.: PCT/KR2023/017601

§ 371 Date: Apr. 10, 2025

(30) Foreign Application Priority Data
Nov. 24, 2022 (KR) 10-2022-0159836

(51) Int. Cl. H01M 10/42; H01M 10/46; H01M 50/204; H02J 7/52; H02J 7/90

(52) U.S. Cl. CPC H01M 10/425; H01M 10/46; H01M 50/204; H02J 7/52; H02J 7/933

(57) ABSTRACT

A parallel connection battery pack assembly employing a structure for preventing damage caused by an inrush current to a battery pack according to an embodiment of the present inventive concept relates to a parallel connection battery pack assembly employing a structure for preventing damage caused by an inrush current to a batter pack, in which multiple battery packs are stacked to be connected in parallel and includes: a negative electrode connection line for connecting negative terminals between adjacent battery packs; a positive electrode connection line for connecting positive terminals between adjacent battery packs; a bypass line formed to be branched off from the positive electrode connection line and blocking parallel connection of at least one battery pack; a switch module for selectively connecting the positive electrode connection line and the bypass line; and a control module for controlling the switch module on the basis of a charging state of the multiple battery packs.

### TECHNICAL FIELD

The present inventive concept relates to a parallel connection battery pack assembly, and more particularly, to a parallel connection battery pack assembly employing a structure for preventing damage to a battery pack caused by inrush current.

### BACKGROUND ART

The use of batteries is rapidly expanding to vehicles driven by electricity (EVs, HEVs, PHEVs) and large-capacity energy storage systems (ESS), as well as mobile devices such as cellular phones, laptop computers, smart phones, smart pads, and the like.

Particularly, in order to secure high energy capacity, parallel connection battery pack assemblies configured to stack a plurality of battery packs 10a, 10b, 10c to be connected in parallel as shown in FIG. 1 are proposed.

These parallel connection battery pack assembly have an advantage in that it is possible to freely change energy capacity by detachably forming a plurality of battery packs 10a, 10b, 10c.

However, when a plurality of battery packs 10a, 10b, 10c is connected in parallel, current flows from a battery pack with a relatively high voltage to a battery pack with a relatively low voltage. In the process of connecting a plurality of battery packs in parallel, current that flows between the battery packs due to the potential difference between the battery packs is referred to as inrush current, and there is a problem in that the circuit or battery may be damaged by the inrush current.

### DISCLOSURE OF INVENTIVE CONCEPT

### Technical Problem

Therefore, the present inventive concept has been made in view of the above problems, and it is an object of the present inventive concept to provide a parallel connection battery pack assembly employing a structure for preventing damage to a battery pack caused by inrush current.

Another object of the present inventive concept is to provide a parallel connection battery pack assembly capable of preventing damage to circuits and batteries caused by inrush current caused by a potential difference between battery packs when a plurality of battery packs is connected in parallel.

The problems to be solved by the present inventive concept are not limited to those mentioned above, and unmentioned other problems can be clearly understood by those skilled in the art from the following description.

### Technical Solution

To accomplish the above objects, according to one aspect of the present inventive concept, there is provided a parallel connection battery pack assembly employing a structure for preventing damage to a battery pack caused by inrush current, and the battery pack assembly is configured to stack a plurality of battery packs to be connected in parallel and comprises: a negative electrode connection line for connecting negative terminals between adjacent battery packs; a positive electrode connection line for connecting positive terminals between adjacent battery packs; a bypass line formed to be branched off from the positive electrode connection line to block parallel connection of at least one battery pack; a switch module for selectively connecting the positive electrode connection line and the bypass line; and a control module for controlling the switch module on the basis of charging states of the plurality of battery packs.

It is preferable that the control module blocks parallel connection of at least one battery pack on the basis of charge rates of the plurality of battery packs.

It is preferable that when a difference in the charge rates between the plurality of battery packs is greater than or equal to a preset first value, the control module controls the switch module to block parallel connection of battery packs of low charge rate.

It is preferable that when the difference in the charge rates between the plurality of battery packs is lower than the preset first value due to discharge of other battery packs while parallel connection of the battery packs of low charge rate is blocked, the control module controls the switch module so that the battery pack, of which the parallel connection is blocked, is reconnected to the other battery packs in parallel.

It is preferable that the control module performs charge and discharge among the battery packs until the difference in the charge rates between the plurality of battery packs connected in parallel is lower than a preset second value.

It is preferable that the parallel connection battery pack assembly includes a first node connected to the positive terminal of any one battery pack among two adjacent battery packs, a second node connected to the positive terminal of the other battery pack, and a third node connected to the bypass line, and the switch module connects two nodes among the first node to the third node under the control of the control module.

It is preferable that the switch module is a metal-insulator transition (MIT) element.

It is preferable that the parallel connection battery pack assembly further includes a communication line for transmitting the charge rates of the battery packs to the control module.

### Advantageous Effects

The parallel connection battery pack assembly employing a structure for preventing damage to a battery pack caused by inrush current according to an embodiment of the present inventive concept may expect an effect of increasing stability of the battery pack assembly by excluding a battery pack having a relatively low charge rate from the current path, and preventing damage to the circuit and battery pack caused by inrush current.

The effects of the present inventive concept are not limited to those mentioned above, and unmentioned other effects can be clearly understood by those skilled in the art from the following description.

### BRIEF DESCRIPTION OF THE DRAWINGS

FIG. 1 is a view showing an example of a parallel connection battery pack assembly configured to stack a plurality of battery packs to be connected in parallel.

FIG. 2 is a conceptual view showing a parallel connection battery pack assembly employing a structure for preventing damage to a battery pack caused by inrush current according to an embodiment of the present inventive concept.

FIG. 3 is a block diagram for explaining the function of a control module in a parallel connection battery pack assembly employing a structure for preventing damage to a battery pack caused by inrush current according to an embodiment of the present inventive concept.

FIGS. 4 to 6 are conceptual views showing various embodiments in which parallel connection of a specific battery pack is blocked according to charging states of battery packs in a parallel connection battery pack assembly employing a structure for preventing damage to a battery pack caused by inrush current according to an embodiment of the present inventive concept.

FIG. 7 is a view showing a case of a battery pack in a parallel connection battery pack assembly employing a structure for preventing damage to a battery pack caused by inrush current according to an embodiment of the present inventive concept.

FIG. 8 is a cross-sectional view for explaining an embodiment of a closing means in a parallel connection battery pack assembly employing a structure for preventing damage to a battery pack caused by inrush current according to an embodiment of the present inventive concept.

FIG. 9 is a plan view showing the cap of FIG. 8.

FIG. 10 is a cross-sectional view taken along line A-A of FIG. 9.

FIGS. 11 and 12 are cross-sectional views for explaining another embodiment of a closing means in a parallel connection battery pack assembly employing a structure for preventing damage to a battery pack caused by inrush current according to an embodiment of the present inventive concept.

### BEST MODE FOR CARRYING OUT THE INVENTIVE CONCEPT

Hereinafter, preferred embodiments of the present inventive concept will be described in detail with reference to the accompanying drawings. Regardless of drawing symbols, the same reference numerals will be given to identical or similar components, and duplicate descriptions thereof will be omitted.

In addition, when it is determined in describing the present inventive concept that a detailed description of a related known technique may obscure the gist of the present inventive concept, the detailed description thereof will be omitted. In addition, it should be noted that the accompanying drawings are only to facilitate easy understanding of the spirit of the present inventive concept, and should not be construed as limiting the spirit of the present inventive concept by the accompanying drawings.

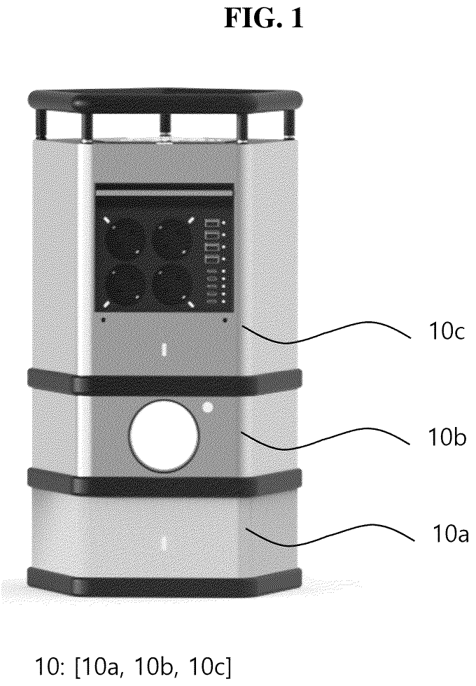

Hereinafter, a parallel connection battery pack assembly employing a structure for preventing damage to a battery pack caused by inrush current according to an embodiment of the present inventive concept relates to a battery pack assembly configured to stack a plurality of battery packs 10 to be connected in parallel. Hereinafter, it will be described focusing on an embodiment in which three battery packs are stacked and connected in parallel as shown in FIG. 1.

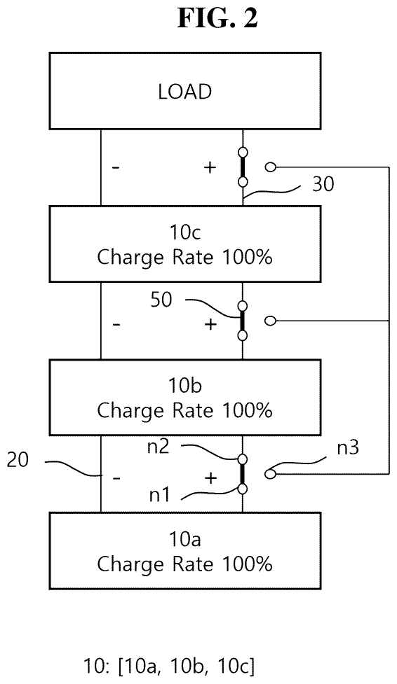

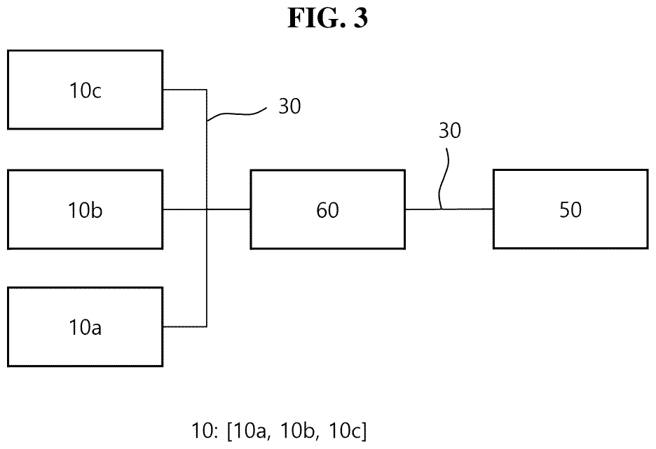

The parallel connection battery pack assembly according to an embodiment of the present inventive concept is configured to connect a first battery pack 10a, a second battery pack 10b, and a third battery pack 10c in parallel, and is configured to include a negative electrode connection line 20, a positive electrode connection line 30, a bypass line 40, a switch module 50, and a control module 60 as shown in FIG. 2.

The negative electrode connection line 20 performs a function of connecting the negative terminals between adjacent battery packs 10, and the positive electrode connection line 30 performs a function of connecting the positive terminals between adjacent battery packs 10.

The bypass line 40 is formed to be branched from the positive electrode connection line 30 and performs a function of blocking parallel connection of at least one battery pack 10.

The switch module 50 performs a function of selectively connecting the positive electrode connection line 30 and the bypass line 40.

Particularly, the parallel connection battery pack assembly according to an embodiment of the present inventive concept includes, as shown in FIG. 2, a first node n1 connected to the positive terminal of any one battery pack 10 among two adjacent battery packs, a second node n2 connected to the positive terminal of the other battery pack 10, and a third node n3 connected to the bypass line 40, and the switch module 50 is configured to connect two nodes among the first node n1 to the third node n3 under the control of the control module 60 described below.

At this point, the switch module 50 may be a metal-insulator transition (MIT) element, and although the switch module 50 is a conductor that ensures electrical connection in normal times, as the switch module 50 changes to an insulator when the surrounding temperature exceeds a preset temperature, accidents such as explosion of the battery pack assembly due to increase in temperature can be prevented.

The control module 60 performs a function of controlling the switch module 50 on the basis of charging states of the plurality of battery packs 10, and to this end, the control module 60 may be provided with a communication line 70 for transmitting and receiving signals to and from the plurality of battery packs 10a, 10b, 10c and the switch module 50.

Particularly, the control module 60 is configured to block parallel connection of at least one battery pack 10 on the basis of charge rates of the plurality of battery packs 10.

Specifically, when the difference in the charge rates between the plurality of battery packs is greater than or equal to a preset first value, the control module 60 controls the switch module 50 to block parallel connection of battery packs 10 of low charge rate.

Basically, as shown in FIG. 2, when the charge rates of the three battery packs 10, i.e., the first battery pack 10a, the second battery pack 10b, and the third battery pack 10c, are all 100%, there is no difference in the charge rates among the three battery packs 10, and the control module 60 connects the first battery pack 10a, the second battery pack 10b, and the third battery pack 10c in parallel by controlling all the switch modules 50 to connect the first node n1 and the second node n2.

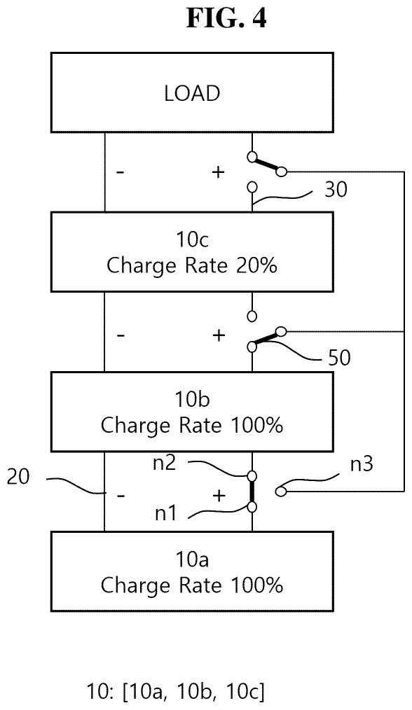

In addition, when the charge rates of the first battery pack 10a and the second battery pack 10b are 100% but the charge rate of the third battery pack 10c is 20%, the control module 60 controls the switch modules 50 so that the positive terminals of the first battery pack 10a and the second battery pack 10b are connected to the load side through the bypass line 40, and the positive terminal of the third battery pack 10c is not connected to the load and the other battery packs 10a and 10b as shown in FIG. 4.

That is, inrush current can be prevented from flowing into the third battery pack 10c by blocking connection of the third battery pack 10c while maintaining parallel connection of the first battery pack 10a and the second battery pack 10b.

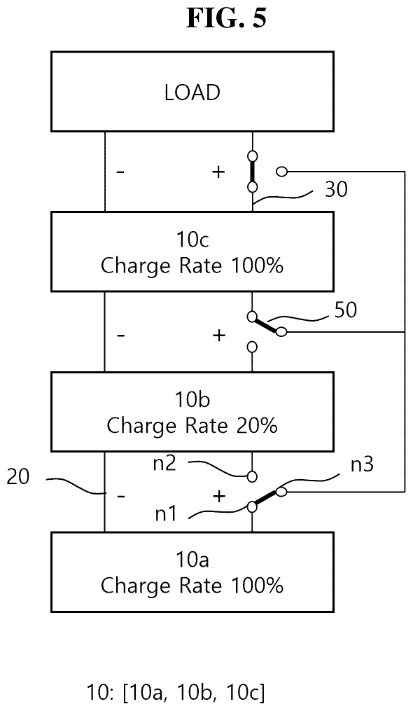

In addition, when the charge rates of the first battery pack 10a and the third battery pack 10c are 100% but the charge rate of the second battery pack 10b is 20%, the control module 60 controls the switch modules 50 so that the positive terminals of the first battery pack 10a and the third battery pack 10c are connected to the load side through the bypass line 40, and the positive terminal of the second battery pack 10b is not connected to the load and the other battery packs 10a and 10c as shown in FIG. 5.

Therefore, inrush current can be prevented from flowing into the second battery pack 10b by blocking connection of the second battery pack 10b while maintaining parallel connection of the first battery pack 10a and the third battery pack 10c.

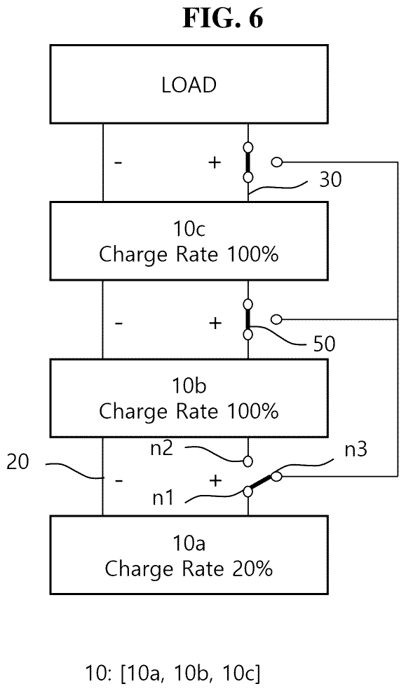

In addition, when the charge rates of the second battery pack 10b and the third battery pack 10c are 100% but the charge rate of the first battery pack 10a is 20%, the control module 60 may control the switch modules 50 so that the positive terminals of the second battery pack 10b and the third battery pack 10c are connected to the load side through the positive electrode connection line 30, and the positive terminal of the first battery pack 10a is connected to the bypass line 40, but the bypass line 40 is not connected to the load as shown in FIG. 6.

Therefore, inrush current can be prevented from flowing into the first battery pack 10a by blocking connection of the first battery pack 10a while maintaining parallel connection of the second battery pack 10b and the third battery pack 10c.

In addition, when parallel connection of any one battery pack 10 is blocked and power is supplied to the load side by the other battery packs 10, the other battery packs 10 are discharged, and therefore, when the difference in the charge rates between the plurality of battery packs 10 is lower than a preset first value, the control module 60 may control the switch modules 50 so that the battery pack 10, of which the parallel connection is blocked, is reconnected to the other battery packs 10 in parallel.

Furthermore, the control module 60 may perform charge and discharge among the battery packs until the difference in the charge rates between the plurality of battery packs 10 connected in parallel is lower than a preset second value, and the second value is preferably smaller than the first value described above.

Meanwhile, the battery pack 10 applied to the parallel connection battery pack assembly employing a structure for preventing damage to a battery pack according to an embodiment of the present inventive concept may be configured to include a case 400 and battery cells accommodated inside the case, and may include microcapsules for cooling down the battery cells to prevent fire that may occur by the battery cells when the temperature inside the case is higher than a preset temperature.

A coolant should have a property of expanding when the surrounding temperature increases like nitrogen, and the microcapsules are preferably formed of polymer resin that is not ruptured in normal times owing to durability and airtightness, and reacts only at a specific temperature, specifically, about 80 to 90 degrees Celsius, inside of the case 400.

That is, when the temperature inside the case 400 increases as the temperature of the battery cells increases, the microcapsules are ruptured at a specific temperature, and although a very small amount of coolant is erupted from one microcapsule, vaporized coolant is erupted and cools down the inside of the battery pack as a large number of microcapsules react explosively and simultaneously, and therefore, a fire inside the battery pack can be prevented.

That is, occurrence of fire inside the battery pack can be fundamentally prevented by the coolant, and therefore, since a combustion chain reaction or the like does not occur, spread of fire can be prevented.

In addition, the battery pack 10 of a parallel connection battery pack assembly according to an embodiment of the present inventive concept may be provided with a function of notifying a user or the like of a situation of cooling down the battery cells inside the battery pack 10 by a fire spread prevention means as the temperature inside the case 400 increases, and for this purpose, it may further include a sensor 700 and a control unit.

The sensor 700 performs a function of detecting at least one among the pressure inside the case 400 due to the coolant and leakage of the coolant discharged toward the outside of the case 400, and the control unit performs a function of notifying at least one among the heated state by the battery cells and the cooling down state by the coolant to the outside, such as a user or the like, on the basis of the detection result of the sensor 700.

Particularly, the control unit should be provided with a wireless communication function for communication with the outside to perform the functions described above, and through this, it may transmit state information to a user designated in advance.

In addition, the sensor 700 may detect the amount or speed of discharging the coolant toward the outside of the case 400 as described above to grasp whether the battery cells 100 of the battery pack 10 are cooled down as the coolant is erupted.

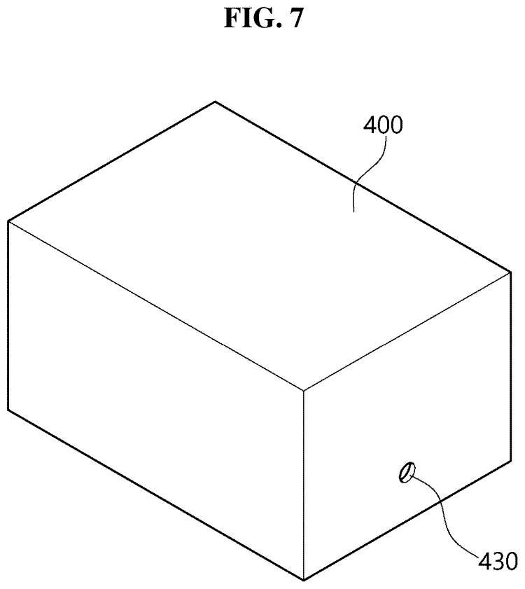

For this purpose, the case 400 may form a discharge hole 430 for discharging the coolant toward the outside as shown in FIG. 7, and since the coolant inside the case 400 is discharged only toward the discharge hole 430, the eruption situation of the coolant may be confirmed accurately.

However, since it is desirable to maintain the closed state of the case 400 in normal times, a closing means 440 for closing the discharge hole 430 is required, and it is desirable that this closing means 440 is configured to be opened on the basis of the amount of coolant flowing into the case 400.

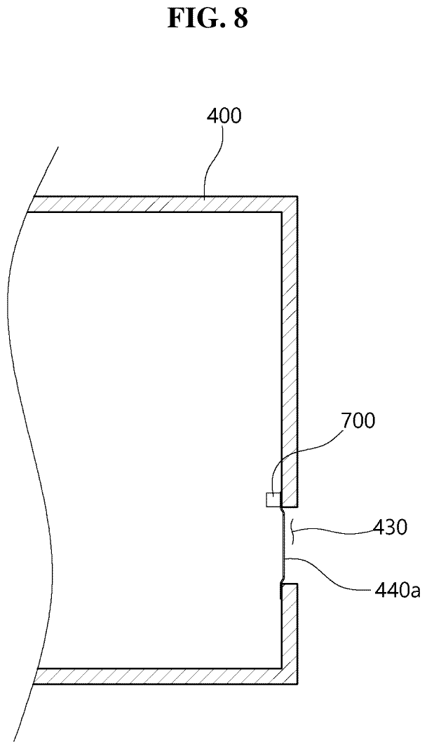

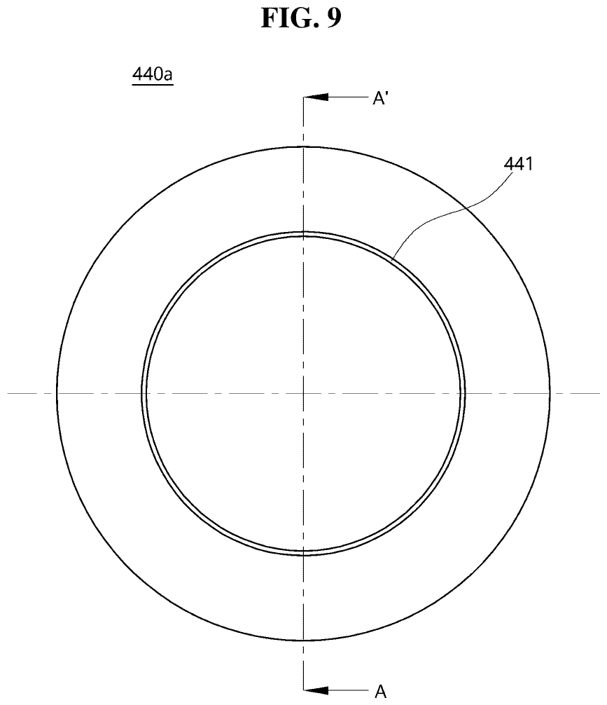

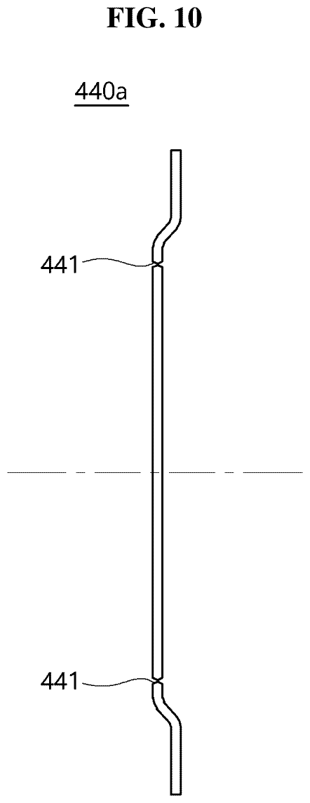

As an embodiment of the closing means 440, the closing means 440 may be a cap 440a having concentric notches 441 formed at a preset distance from the center as shown in FIGS. 8 to 10 to be fractured when a preset pressure is applied.

As shown in FIG. 8, the cap 440a is positioned so that the outer area of the notch 441 is fixedly seated on the inner circumferential surface of the case 400, and the inner area of the notch 441 is arranged to correspond to the discharge hole 430, and is configured such that when the amount of the coolant flowing into the case 400 is larger than a preset value, the notch 441 is fractured so that the coolant is discharged toward the outside through the discharge hole 430.

At this point, the sensor 700 is arranged in an area near the discharge hole 430 to detect whether the coolant is discharged through the discharge hole 430, the speed of discharge, and the like, and when the control unit receives a situation of discharging the coolant through the discharge hole 430 from the sensor, it may determine that cooling down of the battery cells 100 is currently in progress by the coolant, and notify the user of the current situation.

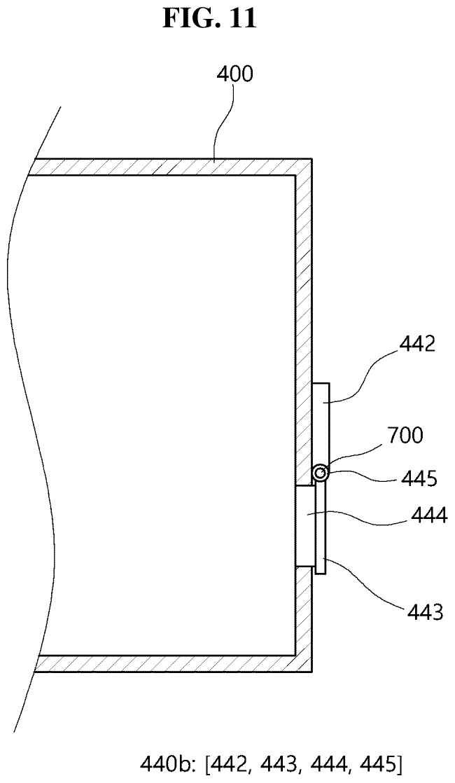

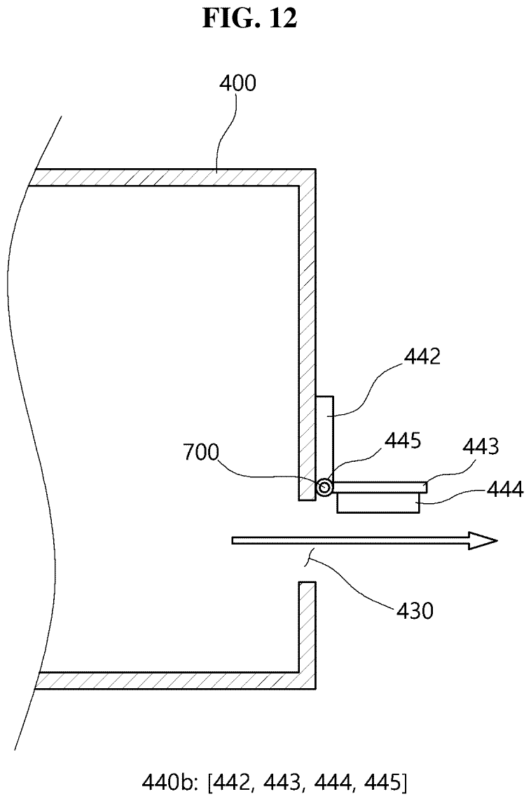

As another embodiment of the closing means 440, the closing means 440 may be configured to include a first plate-shaped member 442, a second plate-shaped member 443, a stopper 444, and an elastic hinge assembly 445 as shown in FIGS. 11 and 12.

The first plate-shaped member 442 is configured to be fixedly coupled to the outer circumferential surface of the case 400, and the second plate-shaped member 443 is configured to include the stopper 444 formed to be rotatably coupled to the first plate-shaped member 442 and inserted into the discharge hole 430.

The elastic hinge assembly 445 is configured to have an elastic body arranged inside thereof and hinge-couple the first plate-shaped member 442 to the second plate-shaped member 443. At this point, the elastic body applies an elastic force to the second plate-shaped member 443 in a direction of inserting the stopper 444 of the second plate-shaped member 443 into the discharge hole 430, and the second plate-shaped member 443 may rotate in a direction opposite to the elastic force on the basis of discharge pressure of the coolant to open the discharge hole 430.

At this point, the sensor 700 may be a rotation sensor that detects the degree of rotation of the second plate-shaped member 443 and may be arranged inside the elastic hinge assembly 445.

That is, although the stopper 444 is firmly coupled to the discharge hole 430 by the elastic body to close the inside of the case 400 in normal times as shown in FIG. 11, when the microcapsules are ruptured due to heat generation of the battery cells 100 and the battery cells 100 are cooled down by the coolant, the pressure inside the case increases, and the second plate-shaped member 443 rotates in a direction opposite to the elastic force as shown in FIG. 12, and therefore, the discharge hole 430 is opened. At this point, a situation of discharging the coolant through the discharge hole 430 may be detected through the sensor 700, and when the control module receives the situation of discharging the coolant to the discharge hole 430 from the sensor, it determines that the battery cells 100 is currently cooled down by the coolant and notifies the user of the current situation.

Furthermore, considering the situation of discharging the coolant detected by the sensor, the control unit may prevent occurrence of fire caused by explosion in advance by opening the power path connected to the battery cells, and minimize spread of fire even when a fire occurs.

Although the present inventive concept has been described above in detail with reference to preferred embodiments, the scope of the present inventive concept is not limited to specific embodiments and should be interpreted by the appended claims. In addition, those skilled in the art should understand that many changes and modifications are possible without departing from the scope of the present inventive concept.

1. A parallel connection battery pack assembly employing a structure for preventing damage to a battery pack caused by inrush current, the battery pack assembly being configured to stack a plurality of battery packs to be connected in parallel, and comprising:
a negative electrode connection line for connecting negative terminals between adjacent battery packs;
a positive electrode connection line for connecting positive terminals between adjacent battery packs;
a bypass line formed to be branched off from the positive electrode connection line to block parallel connection of at least one battery pack;
a switch module for selectively connecting the positive electrode connection line and the bypass line; and
a control module for controlling the switch module on the basis of charging states of the plurality of battery packs.

2. The battery pack assembly according to claim 1, wherein the control module blocks parallel connection of at least one battery pack on the basis of charge rates of the plurality of battery packs.

3. The battery pack assembly according to claim 2, wherein when a difference in the charge rates between the plurality of battery packs is greater than or equal to a preset first value, the control module controls the switch module to block parallel connection of battery packs of low charge rate.

4. The battery pack assembly according to claim 3, wherein when the difference in the charge rates between the plurality of battery packs is lower than the preset first value due to discharge of other battery packs while parallel connection of the battery packs of low charge rate is blocked, the control module controls the switch module so that the battery pack, of which the parallel connection is blocked, is reconnected to the other battery packs in parallel.

5. The battery pack assembly according to claim 1, wherein the control module performs charge and discharge among the battery packs until the difference in the charge rates between the plurality of battery packs connected in parallel is lower than a preset second value.
